(19) United States
(12) Patent Application Publication
(10) Pub. No.: US 2009/0194616 A1
(43) Pub. Date: Aug. 6, 2009

(54) Sporoderm-Broken Polypore Production

(75) Inventors: Siew S. Hiew, San Jose, CA (US); Nan Nan, San Jose, CA (US); Abraham C. Ma, Fremont, CA (US); Au Chi, Union City, CA (US)

Correspondence Address: BEVER HOFFMAN & HARMS, LLP;901 Campisi Way, Suite 370, Campbell, CA, 95008, US

(73) Assignee: Super Talent Electronics, Inc., San Jose, CA (US)

(21) Appl. No.: 12/024,960

(22) Filed: Feb. 1, 2008

(51) Int. Cl. B02C 11/08

(52) U.S. Cl. 241/23; 241/66

(57) ABSTRACT

A cryogenic grinding mill for grinding organic base material pieces into sub-micron-sized powder particles. An upper grinding block is rotated relative to a stationary lower grinding block by a motor, and is maintained at a temperature below −150° C. by a cryogenic system including an annular liquid nitrogen chamber disposed around the grinding blocks. The upper grinding block defines a trench for receiving base material pieces fed by a feed system, and includes through-holes that extend from the trench to a grinding region formed between the grinding surfaces of the upper and lower blocks. When the upper grinding block is rotated, the base material pieces are gravity-fed from the trench to the grinding region, and ground powder material is forced to a peripheral edge of the grinding region. The powder material is then filtered, and particles having an undesirably large size are fed back into the trench for re-grinding.

### FIELD OF THE INVENTION

The present invention relates to the volume production medicines derived from selected base materials (e.g., polypores or herbs), and in particular to methods and apparatus associated with the volume production of such medicines.

### BACKGROUND OF THE INVENTION

Polypores are a group of tough, leathery poroid mushrooms similar to boletes, but typically lacking a distinct stalk, and, unlike boletes, polypores do not have the spore-bearing tissue continuous along the entire underside of the mushroom. Although not generally considered edible, two polypores in use today for medicinal purposes are Ganoderma lucidum and Trametes versicolor.

Língzhī (Chinese) or reishi (Japanese) is the common name for Ganoderma lucidum, which are one type of polypore believed to have high medicinal effects on patients with hypertension, hepatitis, AIDS, cancer, diabetes, cardiovascular diseases, immunological disorders, and the ability to reduce, if not inhibit, free radical oxidation, high cholesterol and hepatotoxicity. Thus, some aged Ganoderma lucidum have high monetary value. Consumers of Ganoderma lucidum normally slice them in thin pieces or pound them in powder form before they process and consume. Unfortunately, most of the essential nutrients and beneficial enzymes are stored in the double walled basidiospore, which is a very tiny and hard to crack open type of protective layer. The double-walled protected medicinal essence is at least ten folds higher than the other parts of the Ganoderma lucidum per unit weight. Because the human body cannot digest and breakdown the walls of the tiny spores, the medicinal value of Ganoderma lucidum is greatly reduced. In order to extract most of the nutrient and medicinal properties of the Ganoderma lucidum, an effective method of producing sporoderm-broken polypores is needed.

U.S. Pat. No. 6,316,002 by Liu et al describes a method for germination activating red Ganoderma lucidum spores by soaking the spores in a solution (water, saline, and nutritional solution) to cause the spores to germinate, and placing the germination treated spores in a culture box between 10 minutes and 10 hours at relative humidity of 60%-98% and temperature of 16-48° C. to induce the synthesis of bioactive substances and softening of the cell walls of the spores. Next, the germination activated spores are treated with wall-breaking enzymes and/or mechanical force (which include micronization, roll pressing, grinding, ultrasound, and super high pressure microstream treatment) to produce sporoderm-broken ganoderma spores. In a last production stage, the bioactive substances are extracted from the sporoderm-broken spores by drying at low temperature followed by extraction.

The prior art method of producing sporoderm-broken polypores taught in U.S. Pat. No. 6,316,002 has several problems. First, the method involves extensive wait time for spores to germinate under a wide range of loose controlled temperature and humidity environment, followed by mechanical means of breaking down the strong protective walls of polypores. This method of producing germination activated red Ganoderma lucidum spores is not suitable to produce volume quantity of sporoderm-broken polypores for commercialization. Worst of all, most of the enzymes are killed by the high temperatures utilized during the process.

What is needed is a method and apparatus for generating powders from selected base materials that suitable for producing volume quantities of fine powders from organic base materials. In particular, what is needed is a method and apparatus for generating sporoderm-broken polypores for commercialization that avoids the problems associated with conventional methods.

### SUMMARY OF THE INVENTION

The present invention is directed to a cryogenic grinding mill and method for processing polypores, herbs and other organic base materials in the cryogenic grinding mill such that the base materials are maintained at a cryogenic temperature (e.g., lower than −150° C.), thereby facilitating the large volume production of powdered medicinal and nutritional products in a manner that both avoids long processing times and undesirable degradation of the base materials.

In accordance with an embodiment of the present invention, a cryogenic grinding mill is used for grinding organic base material pieces into small (e.g., micron- or sub-micron-sized) powder particles. The grinding mill includes an upper grinding block that is rotated relative to a fixed (stationary) lower grinding block by a motor, with both the upper and lower grinding blocks being maintained at a temperature below −150° C. by a cryogenic system. In a disclosed an embodiment, the cryogenic system includes an annular (donut-shaped) liquid nitrogen chamber disposed around the upper and lower grinding blocks. The upper grinding block defines a trench for receiving the base material pieces fed into the grinding mill by a suitable feed system, and includes through-holes that extend from the trench to a lower grinding surface of the upper grinding block. The lower grinding block has an upper grinding surface disposed below and in contact with the lower grinding surface of the upper grinding block, whereby a grinding region is formed therebetween. When the upper grinding block is rotated relative to the lower grinding block, the base material pieces are gravity-fed from the trench to the grinding region and are ground into powder material that is forced to a peripheral edge of the grinding region. The powder material is then filtered, and particles having an undesirably large size are fed back into the trench for re-grinding. The liquid nitrogen chamber maintains the grinding mill and base materials below −150° C. during the grinding process, and an extremely cold cryogenic temperature serves to preserve the enzymes in the powder material from high temperature induced damage. Another major function of extreme cold temperature is to make the spores brittle during grinding process, thereby facilitating the production of micron- and sub-micron-sized powder particles that are particularly useful for the production of medicines. Thus, the cryogenic grinding mill and production method are well suited for processing polypores and other expensive herbal health supplements, such as ginseng, cordyceps sunensis, maca root and green tea, thereby facilitating the large volume production of powdered medicinal and nutritional products in a manner that both avoids long processing times and undesirable degradation of the base materials.

### BRIEF DESCRIPTION OF THE DRAWINGS

These and other features, aspects and advantages of the present invention will become better understood with regard to the following description, appended claims, and accompanying drawings, where:

FIG. 1 is a cross-sectional perspective view showing one-half of a cryogenic grinding apparatus according to an embodiment of the present invention;

FIG. 2 is a flow diagram showing a simplified method for producing powders using the cryogenic grinder of FIG. 1 according to another embodiment of the present invention;

FIG. 3 is a completed perspective view showing the cryogenic grinder of FIG. 1 in additional detail;

FIG. 4 is a perspective view showing an upper grinding block of the cryogenic grinder of FIG. 1;

FIGS. 5(A) and 5(B) are top plan view and cross-sectional side views, respectively, showing the upper grinding block of FIG. 4;

FIG. 6 is a bottom perspective view showing the upper grinding block of FIG. 4;

FIGS. 7(A) and 7(B) are bottom plan and enlarged cut-away cross-sectional side views, respectively, the upper grinding block of FIG. 4 in additional detail; and

FIG. 8 is a flow diagram showing a method for producing medicines from polypores using the cryogenic grinder of FIG. 1 according to another embodiment of the present invention.

### DETAILED DESCRIPTION OF THE DRAWINGS

The present invention relates to an improvement in the production of medicinal powders from organic base materials. The following description is presented to enable one of ordinary skill in the art to make and use the invention as provided in the context of a particular application and its requirements. As used herein, directional terms such as “upper”, “upwards”, “lower”, “downward”, “front”, “rear”, are intended to provide relative positions for purposes of description, and are not intended to designate an absolute frame of reference. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

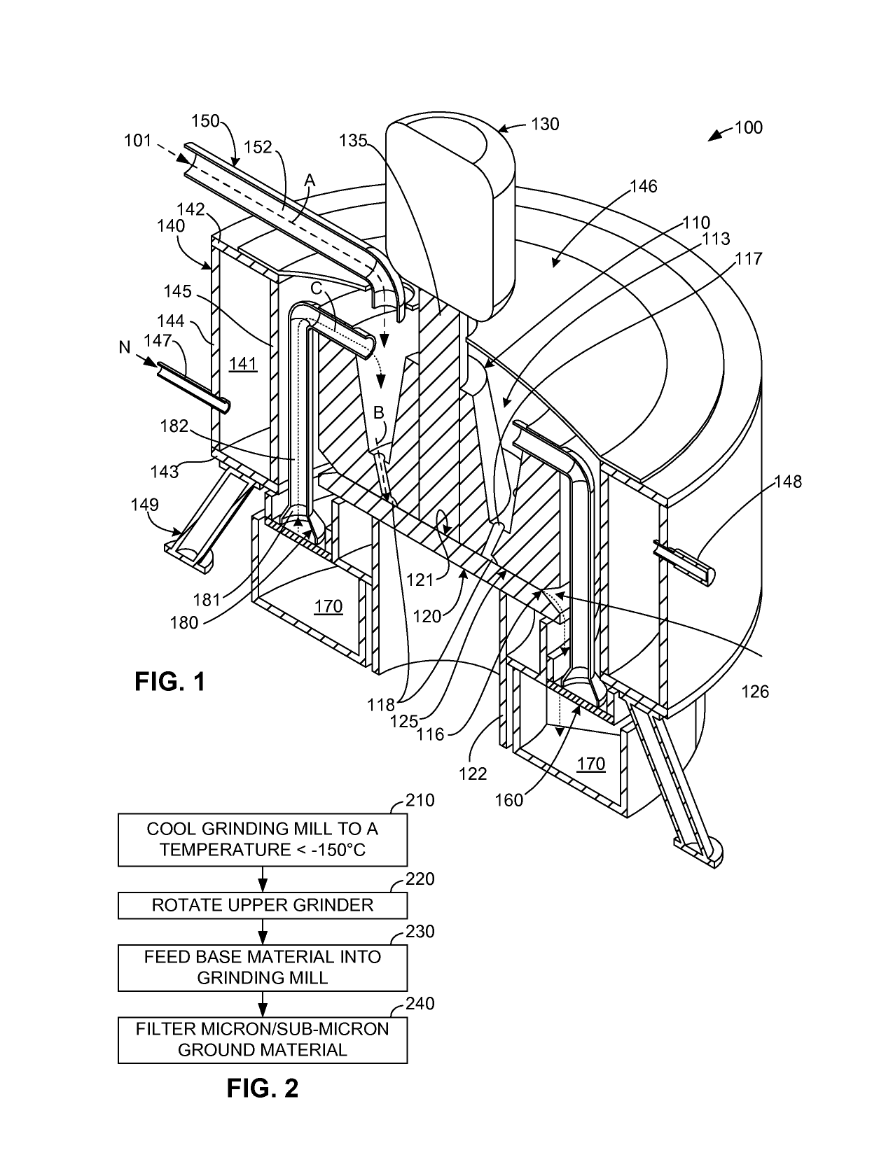

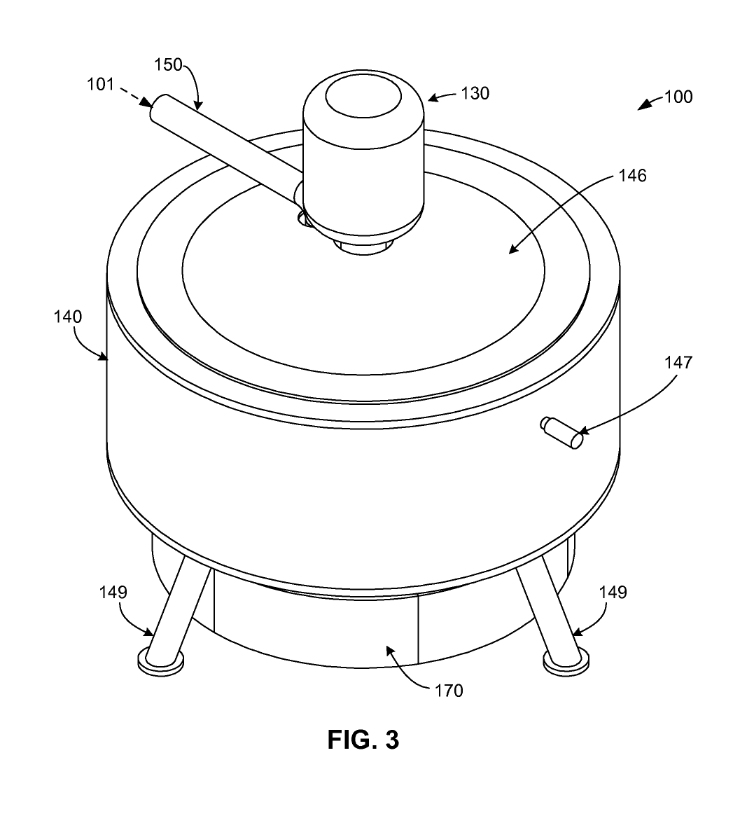

FIGS. 1 and 3 are cross-sectional perspective and completed perspective views showing a cryogenic grinding mill 100 for processing polypores, herbs and other organic base materials 101 that are fed into cryogenic grinding mill 100 in accordance with an embodiment of the present invention. Referring to FIG. 1, cryogenic grinding mill 100 includes an upper grinding block 110 and a fixed (stationary) lower grinding block 120 disposed in a central grinding chamber. A motor 130 is disposed above the grinding chamber and is supported by an external fixed support (not shown) in order to facilitate rotation of upper grinding block 110 relative to lower grinding block 120. Upper grinding block 110 and lower grinding block 120 are surrounded and cooled by a cryogenic system 140. A feed system 150 is provided to feed base materials 101 along a feedpipe 152 (as indicated by dashed-line arrow A in FIG. 1) into a cylindrical V-shaped trench 113 defined in upper grinding block 110. Through-holes 117 are formed at the bottom of trench 113 that allow the base material to feed into a grinding region 125 defined between upper grinding block 110 and lower grinding block 120, as indicated by dashed-line arrow B in FIG. 1. A vibrating sift filter 160 is located under a peripheral edge 126 of grinding region 125 to catch ground materials forced therefrom, and to pass suitably-sized particles (e.g., micron- or sub-micron-sized powder particles) that fall into an annular collection bin 170. Particles that are larger than the desired size remain on the surface of filter 160, and are sucked up and fed back into trench 115 by a particle feedback system 180, as indicated by the dotted-line arrow C extending up through the feedback pipe 182 in FIG. 1.

FIG. 2 is a flow diagram showing a simplified method for producing micron/sub-micron sized powder particles utilizing cryogenic grinding mill 100 (shown in FIG. 1) from an organic base material such as Ganoderma lucidum or another polypore. The simplified method involves cooling upper and lower grinding blocks 110 and 120 of grinding mill 100 (shown in FIG. 1) to a temperature below −150° C. (step 210), rotating the upper grinding block 110 relative to lower grinding block 120 in a way that facilitates a grinding action in grinding zone 125 (block 220), feeding base materials 101 into trench 113 (block 230), and filtering the ground particles forced from grinding region 125 such that any micron/sub-micron sized powder particles generated by the grinding process are passed into collection bin 170. The apparatus of FIGS. 1 and 3 and simplified method of FIG. 2 are described in additional detail in the following paragraphs.

Referring to the central portion of FIG. 1, upper grinding block 110 and lower grinding block 120 are metal or rock-type grinding structures that are constructed using know techniques to produce grinding region 125 therebetween.

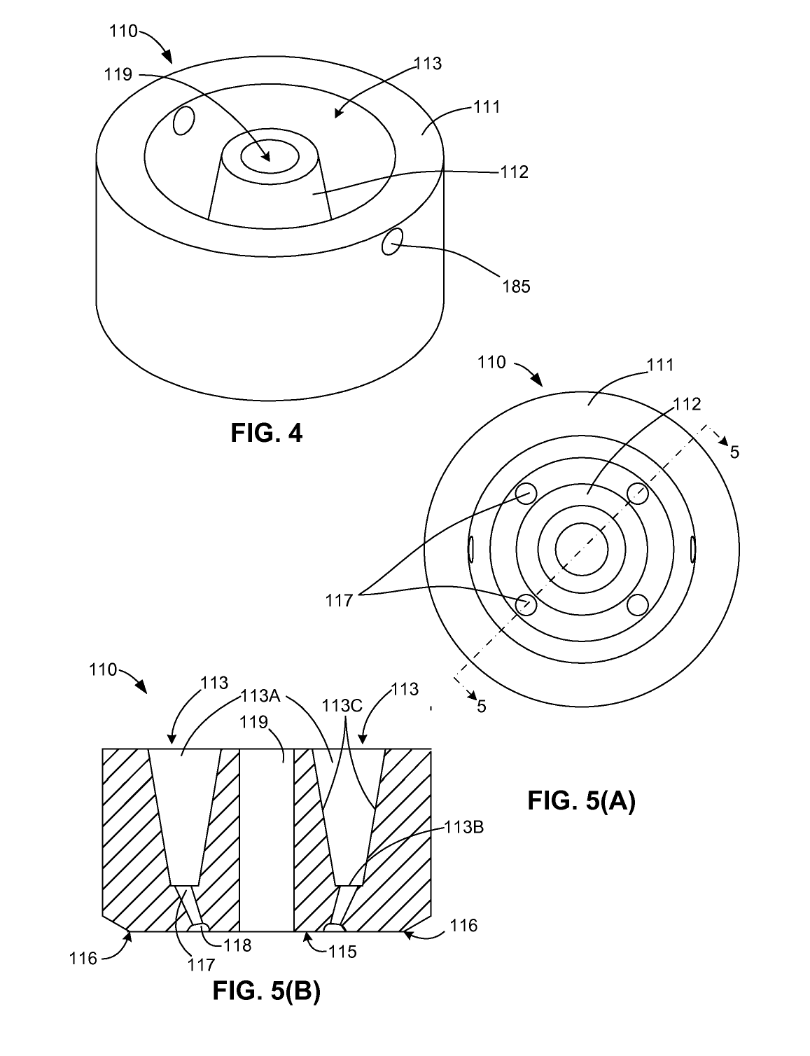

FIGS. 4, 5(A), and 5(B), show the upper portion of upper grinding block 110 in additional detail. Upper grinding block 110 includes a substantially cylindrical outer portion 111 and a cone-shaped inner portion 112 that define 360° V-shaped trench 113 therebetween. As shown in FIG. 5(B), trench 113 has a relatively wide upper opening 113A, a relatively narrow, closed lower end 113B, and opposing side walls 113C that taper from upper opening 113A to lower end 113B. As indicated in FIG. 5(A), four through-holes 117 are defined at lower end 113B of trench 113, and as shown in FIG. 5(B), define a passage leading from trench 113 to lower grinding surface 115. Through-holes 117 slant at an angle from lower end 113B of V-shape trench 113 to the lower surface 115 of upper grinding block 110, and terminate at elongated curved cavities 118 (discussed in additional detail below). Inner portion 112 defines a central axial opening 119 that is used to connect upper grinding block 110 to a metal motor shaft 135 (shown in FIG. 1).

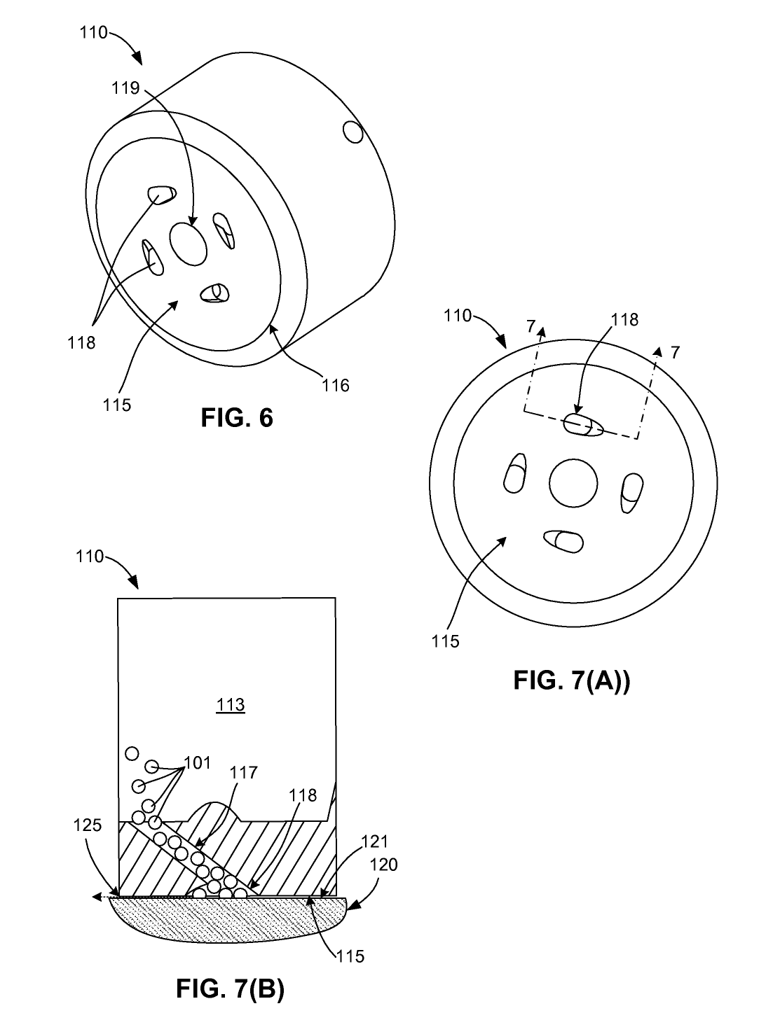

FIGS. 4, 5(A), and 5(B), 6, 7(A) and 7(B) show the lower portion of upper grinding block 110 in additional detail. Lower grinding surface 115 is substantially disk-shaped surface having a peripheral edge 116, and defines four curved cavities 118 that respectively communicate with associated through-holes 117 (discussed above). As indicated in FIG. 7(B), each elongated curved cavity 118 is tapered off in the direction opposing the spin of upper grinding block 110 during the grinding operation, whereby rotation of upper grinding block 110 facilitates the feeding of base material 101 from trench 113 down through-holes 117 into elongated curved cavities 118, where the base materials are dragged into the extremely narrow grinding region 125 between lower grinding surface 115 and upper grinding surface 121 of stationary lower grinding block 120. The resulting grinding action causes the base material pieces to be ground into powder-like particles that are forced out of grinding region 125.

Referring again to FIG. 1, lower grinding block 120 is a disk-shaped structure defining very flat upper grinding surface 121, and is supported on a hollow cylindrical base structure 122. In alternative embodiments, base structure 122 may be solid, or replaced by an integral extension of lower grinding block 120.

Referring to the upper portion of FIG. 1, shaft 135 extends from motor 130, and is rigidly secured to upper grinding block 110 in a manner that facilitates rotation of upper grinding block 110 around an axis defined by shaft 135. As upper grinding block 110 spins at low rotating speeds (e.g., approximately 1 to 10 RPM), the coarse or granular sized base material 101 is ground in grinding region 125 (i.e., between upper grinding surface 121 and lower grinding surface 115) into very tiny sizes powder particles that are forced to peripheral edge 126, which then fall onto filter 160, which is discussed below. In one embodiment, motor 130 includes a variable speed control that allows the rotating speed to be optimized depending on the density of base material 101. That is, if motor 130 spins too fast for a given material, the ground material may end up sticking and piling on the side wall of the through holes 117 due to centrifugal force. Therefore, the speed of motor 130 may be optimized for each batch of base material.

In accordance with an aspect of the present invention, cryogenic system 140 is cooled to a temperature of less than −150° C. (i.e., upper grinding block 110 and lower grinding block 120 are maintained at a temperature below −150° C.) using liquid nitrogen. In the disclosed embodiment, an annular chamber 141 is formed by a disk-shaped upper wall 142, a disk-shaped lower wall 143, an outer cylindrical wall 144, and an inner cylindrical wall 145. Outer cylindrical wall 144 and inner cylindrical wall 145 are concentric, and define a central region in which upper grinding block 110 and lower grinding block 120 are disposed. A cover 146 (shown in FIGS. 1 and 3) is disposed over the central region, and defines openings for shaft 135 and feedpipe 152, which is discussed below. An inlet pipe (port) 147 is attached to outer wall 144, and serves to feed liquid nitrogen, which has a boiling temperature of −195.8° C., into annular chamber 141. In addition, a pressure relief valve 148 is mounted on outer wall 144, and is attached to and controlled by a pressure sensor (not shown) mounted inside chamber 141, which is set to regulate the gas phase pressure of the N₂ in chamber 141 according to known techniques. Upper wall 142, lower wall 143 and outer cylindrical wall 144 comprise materials having good heat insulating properties (e.g. wood or non-conductive synthetic materials) in order to keep the temperature in the grinding chamber as low as possible, whereas inner cylindrical wall 145 comprises a material having good heat conductive properties (e.g. metal or heat conductive synthetic materials). Cryogenic system 140 is secured and supported by a plurality of solid or hollow leg supports 149.

As indicated in FIG. 1, feeding base material 101 into trench 113 involves passing base material 101 along feedpipe 152 along the path indicated by arrow A, which extends into an opening formed in cover 146. In one embodiment, base material 101 is passed along feedpipe 152 by way of a drive screw (not shown). The fed base materials 101 fall into trench 113 and settles to the bottom for feeding into lower opening holes 118. Base materials 101 are then drawn through holes 117 to grinding region 125, and ground powder falls from peripheral region 126 onto filter 160.

Filter 160 is a mesh-type structure that serves to filter ground particles forced from grinding region 125 such that particles of a selected size (e.g., micron or sub-micron sized powder particles) are passed into collection bin 170, and particles larger than the selected size are retained on an upper surface of filter 160. In one embodiment, filter 160 is disposed on a vibrating mechanism (not shown) that is disposed in the hollow region defined by cylindrical base structure 122 such that filter 160 forms a vibrating sift suitably designed for filtering finer than micron size or sub-micron size powder particles and block and coarser size particles. Sift filter is made of ultra thin metal or alloy sheet (such as copper or copper alloy. Copper is preferred because copper is biostatic and bacteria will not grow on the surfaces of copper. Copper is also an essential trace nutrient to all high plants and animals. It is found in the bloodstream of human, as a co-factor in various enzymes and in copper-based pigments. The donut-shaped sift filter is made up of support frame with plurality of 6 to 8 inches in diameter of very thin circular metal disks (with populated micron size holes evenly distributed one inch away from the circular edge, with the outer 1″ solid ring is reserved for taping on the support frame structure) that are mounted on the support frame structure. The copper disk's micron holes are fabricated using known semiconductor processing technology equipment that apply photolithography and dry etching known techniques of the semiconductor field. In one embodiment, mesh filter 160 can be changed from micron size to sub-micron size, if necessary, the trade off for finer size sift is that it takes longer time to complete the grinding process than the larger size sift. To change the filter size, the support frame structure together with the plurality of filter blades are removed and replaced with another support frame structure with finer or coarser filter blades.

In accordance with embodiment of the present invention, a feedback system 180 serves to feed the ground particles disposed on filter 160 (e.g., those particles larger than micron/sub-micron sized powder particles that pass through filter 160 into bin 170) back into trench 113. Feedback system 180 includes vacuum suction heads 181 that are disposed to pass over the surface of filter 160, and feedpipes 182 that feed the particles along the path indicated by dotted arrow C back into trench 113 using a drive screw feed system (not shown). Referring to FIG. 4, openings 185 are defined through the upper portion of upper grinding block 110 to receive upper ends of feed pipes 182 (as shown in FIG. 1), which are attached such that suction heads 181 and feedpipes 182 (see FIG. 1) are rotated with upper grinding block 110 during the grinding process. The continuous process of grinding, sifting, and feeding back larger sized particles back to the 360° V-shape grinder trench 113 continues under extreme low temperature with slow spin speed of upper grinder block 110 until all base material 101 is ground up and collected in bins 170.

In accordance with a specific embodiment of the present invention, cryogenic grinding mill 100 and the method of FIG. 2 (both discussed above) are utilized to process organic base materials to produce medicines and health food supplements. In this instance, the extreme low temperature (i.e., below −150° C.) must be maintained during the grinding process to preserve the nutrient and the enzyme of the organic base material. Health food supplements, such as ganoderma lucidum, ginseng, cordyceps sunensis and other expensive herbs, roots or plants are thus successfully broken down into micro size particles in order to increase the exposed surface area. In the case of ganoderma lucidum, which stores its essential nutrients and enzymes in the double walled basidiospores, the extreme low temperature is necessary to freeze the walled spores so that they become brittle in the grinding process, which helps break up the walls to expose the inner contents of the double walled basidiospores, thus producing a medicinal powder on a commercial scale that is suitable for treating patients with hypertension, hepatitis, AIDS, cancer, diabetes, cardiovascular diseases, immunological disorders, and the ability to reduce, if not, inhibit free radical oxidation, high cholesterol and hepatotoxicity.

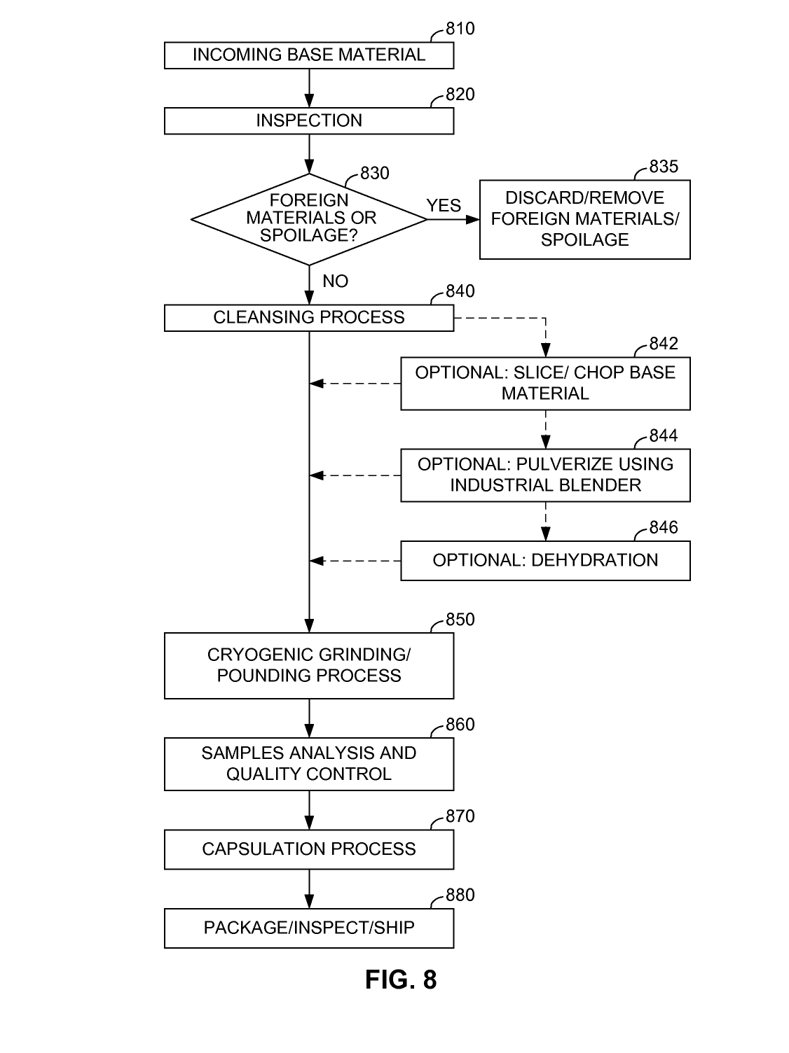

FIG. 8 is a flow diagram showing a detailed method of processing polypore/herbal materials into sub-micron size powder. The process flow is described as follow with reference to the block numbers shown in FIG. 8. The process begins with the incoming materials such as Ganoderma lucidum, ginseng, cordyceps sunensis and other herbs, roots or plants that have nutritional or medicinal properties (block 810). The incoming materials are subjected to quality control inspection and screening (block 820). Production operators then check for either foreign materials or spoilage materials (block 830). If either or both types of contaminant are found in the lot, the foreign and spoilage materials are removed from the incoming materials (block 835). The good incoming materials then go through cleaning process where the incoming materials are flushed and rinsed with strong clean water jets (block 840). The wet herbal materials are then sliced and chopped into small pieces (in the case of simple and smaller herbal materials such as green tea, this process is optional; block 842). The small pieces are then poured into the heavy duty industrial blender to pulverize into granular size (this process is also optional for green tea; block 844). The pulverized powder is then subjected to dehydration process to remove all the water and moisture contents in the granular size powder (this is also another optional step for green tea; block 846). The dry granular size materials are then piped into the cryogenic grinding machine (in the manner described above) where the granular size materials are ground up in an extremely cold temperature chamber (below −150° C.; block 850). At this cryogenic temperature, the grinding chamber can reach −195° C. with longer soak time, whereby the target base materials (which are hard to breakdown at room temperature) became very brittle and can be crushed with normal pounding force or grinding force. In scientific and microscopic term, the bonding forces between atoms are significantly reduced at extreme cold temperature. The final ground up powder particle size is in sub-micron range. A quality control staff then samples the extreme fine powder for elements analysis and water solubility (block 860). The results of the ground powder lot are recorded and filed for future reference. The bulk of the sub-micron size powder is then packed into individual capsules in a medical grade encapsulation machine (block 870). The capsules are packaged into bottles with proper logo, barcode, content information, usage direction and other necessary information on the outside label (block 880). The bottles are vacuum sealed and capped, and then packed into paper boxes and then wrapped by transparent or colored pattern plastic sheet, followed by passing through a heat station to tighten the plastic wrap. The final products are packed into a larger cartoon box and ready to ship to customers.

Although the present invention has been described with respect to certain specific embodiments, it will be clear to those skilled in the art that the inventive features of the present invention are applicable to other embodiments as well, all of which are intended to fall within the scope of the present invention. For example, the production process described above may be at least partially involves pounding at cryogenic temperatures in place of the grinding process.

1. A method for producing powder particles from an organic base material, the method comprising:
cooling a process mill to a temperature below −150° C., wherein the mill includes means for performing at least one of grinding and pounding said base material into a powder;
feeding said base material into the mill such that said powder is generated; and
filtering said powder to remove powder particles that are larger than a predetermined size.

2. The method of claim 1,
wherein cooling the process mill comprises cooling grinding mill including:
an upper grinding block defining a trench, a lower grinding surface having an outer edge, and one or more through-holes extending from said trench to said lower grinding surface, and
a lower grinding block having an upper grinding surface disposed below and in contact with the lower grinding surface of said upper grinding block, whereby a grinding region is formed between said upper grinding surface and said lower grinding surface, and a peripheral edge of said grinding region is located adjacent to the outer edge of said upper grinding surface;
wherein the process further comprises rotating the upper grinding block relative to the lower grinding block such that said lower surface of said upper grinding block grinds against the upper grinding surface of said lower grinding block.

3. The method of claim 2, wherein cooling the grinding mill comprises:
disposing said grinding mill inside an annular cryogenic container; and
filling said annular cryogenic container with liquid nitrogen.

4. The method of claim 2, wherein rotating the upper grinding block comprises connecting a central portion of said upper grinding block to a shaft, and rotating said shaft using a motor.

5. The method of claim 2,
wherein feeding said base material comprises feeding one of ganoderma lucidum, ginseng, cordyceps sunensis, a herb, a root and a plant into the trench of said upper grinding block, causing said base material pieces to feed from said trench to said grinding region through said one or more through holes, causing said fed base material pieces to be ground into particles that are smaller than said base material pieces, and causing said ground particles to be forced out of said grinding region by way of said peripheral edge; and
wherein filtering comprises filtering said ground particles forced from said grinding region such that micron/sub-micron sized powder particles are passed into a collection bin, and particles larger than said micron/sub-micron sized powder particles are retained on a filter surface.

6. The method of claim 5, further comprising, before performing said feeding:
inspecting the base materials and removing impurities; and
at least one of cleaning the base material, slicing/chopping the base material, pulverizing the base material, and dehydrating the base material.

7. The method of claim 1, wherein filtering further comprises feeding said particles larger than said micron/sub-micron sized powder particles back into said trench.

8. A cryogenic grinding mill for grinding base material pieces into micron/sub-micron sized powder particles, the grinding mill comprising:
an upper grinding block defining a trench for receiving said base material pieces, a lower grinding surface having a peripheral edge, and one or more through- holes extending from said trench to said lower grinding surface;
a lower grinding block having an upper grinding surface disposed below and in contact with the lower grinding surface of said upper grinding block, whereby a grinding region is formed between said upper grinding surface and said lower grinding surface, and a peripheral edge of said grinding region is located adjacent to the peripheral edge of said upper grinding surface;
rotating means for rotating the upper grinding block relative to the lower grinding block such that said lower surface of said upper grinding block moves relative to said lower grinding block, whereby said base material pieces are fed from said trench to said grinding region and ground into particles that are smaller than said base material pieces, and said ground particles are forced to said peripheral edge of said grinding region; and
cooling means for maintaining said upper grinding block and said lower grinding block at a temperature below −150° C.

9. The cryogenic grinding mill according to claim 8,
wherein each of said through-holes is slanted at an angle from a floor of the trench to the bottom grinding surface of the upper grinding block, and
wherein bottom grinding surface defines one or more elongated curved cavities, each said elongated curved cavity being tapered off in the direction opposing the spin of the grinding block.

10. The cryogenic grinding mill according to claim 8, wherein said cooling means comprises an annular chamber defined by concentric outer and inner cylindrical walls surrounding the upper grinding block and the lower grinding block, and means for feeding liquid nitrogen between the concentric outer and inner cylindrical walls such that the upper grinding block and the lower grinding block are maintained at said temperature below −150° C.

11. The cryogenic grinding mill according to claim 10, wherein the cooling means further comprises top and bottom ring plates respectively connected to upper and lower edges of said concentric outer and inner cylindrical walls, whereby said annular chamber is defined between said top and bottom ring plates and said concentric outer and inner cylindrical walls.

12. The cryogenic grinding mill according to claim 8, further comprising means for feeding said base materials from an external source into the trench of the upper grinding block.

13. The cryogenic grinding mill according to claim 8, further comprising:
a filter disposed under said peripheral edge of said grinding region, said filter including openings sized such that said micron/sub-micron sized powder particles to pass therethrough into a collection bin, and particles larger than said micron/sub-micron sized powder particles are retained thereon; and
means for moving said particles larger than said micron/sub-micron sized powder particles from said filter to said trench of said upper grinding block.

14. The cryogenic grinding mill according to claim 13, further comprising means for vibrating said filter.

15. The cryogenic grinding mill according to claim 13, wherein said means for moving comprises:
a suction head disposed over said filter, and
a feedback pipe connected to said upper grinding block and arranged such that said particles drawn into said suction head are deposited into said trench.

16. The cryogenic grinding mill according to claim 8,
wherein said upper grinding block comprises a substantially cylindrical structure such that said upper surface and said lower grinding surface are substantially disk-shaped,
wherein said trench comprises a V-shaped annular groove including an upper opening having a first width defined in said disk-shaped surface, a closed lower end having a second width, and opposing side walls that taper from upper opening to lower end, wherein the first width is wider than the second width.

17. The cryogenic grinding mill according to claim 8, wherein said upper grinding block and said lower grinding block comprises one of metal and rock.

18. The cryogenic grinding mill according to claim 8, wherein said rotating means comprises a motor disposed above said upper grinding block, and a metal shaft extending from said motor and fixedly connected to a central axis of said upper grinding block.
